(19) United States
(12) Patent Application Publication
(10) Pub. No.: US 2026/0098326 A1
(43) Pub. Date: Apr. 9, 2026

(54) LOW-ALLOY STEEL, PLATE AND WELDED PIPE RESISTANT TO CARBON DIOXIDE AND MICROORGANISM CORROSION, AND MANUFACTURING METHOD THEREFOR

(71) Applicant: BAOSHAN IRON & STEEL CO., LTD., Shanghai (CN)

(72) Inventors: Yameng Qi, Shanghai (CN); Chunxia Zhang, Shanghai (CN); Zhonghua Zhang, Shanghai (CN); Zhan Gao, Shanghai (CN)

(21) Appl. No.: 19/112,711

(22) PCT Filed: Sep. 25, 2023
(86) PCT No.: PCT/CN2023/121089

§ 371 Date: Mar. 18, 2025

(30) Foreign Application Priority Data
Sep. 28, 2022 (CN) 202211190188.1

(51) Int. Cl. C22C 38/00; C21D 8/0221; C21D 8/0247; C21D 8/10; C21D 9/08; C21D 9/46; C22C 38/42; C22C 38/44; C22C 38/46

(52) U.S. Cl. CPC C22C 38/005; C21D 8/0221; C21D 8/0247; C21D 8/10; C21D 9/085; C21D 9/46; C22C 38/42; C22C 38/44; C22C 38/46; C21D 2211/005; C21D 2211/009

(57) ABSTRACT

The present application discloses a low alloy steel, comprising, in addition to Fe and inevitable impurities, the following chemical elements in percentage by mass: C: 0.02-0.1%, Si: 0.1-1.5%, Mn: 0.10-1.8%, Cr: 1.0-5.5%, Ni: 0.3-3.0%, Cu: 0.3-4.8%, Mo: 0.10-2.5%, V: 0.01-0.2%, Al: 0.01-0.1%, REM: 0.1-1.0%. The low alloy steel of the present disclosure has good resistance to carbon dioxide and microbiologically caused corrosion and is suitable for working environments where microbiologically caused corrosion and CO₂ corrosion coexist. In addition, the present application discloses a plate and a welded pipe made from the low alloy steel, and methods for manufacturing the plate and welded pipe.

### TECHNICAL FIELD

The present disclosure relates to a low alloy steel and a plate and a welded pipe made therefrom, and in particular to a low alloy steel, a plate, and a welded pipe resistant to corrosion (in particular to carbon dioxide and microbiologically caused corrosion), and a method of manufacturing thereof.

### BACKGROUND

Microbiologically caused corrosion refers to the phenomenon caused by microorganisms' own life activities and their metabolites that accelerates the corrosion process of metal materials directly and indirectly. Microorganisms are commonly found in various natural environments, such as soil, seawater, oilfield systems, etc., and are a major cause of failure of engineering materials. Statistics show that microbiologically caused corrosion of metal materials accounts for about 20% of the total corrosion of metal materials, resulting in huge economic loss.

Microbiologically caused corrosion is usually a synergistic corrosion process of multiple microorganisms. Microorganisms such as sulfate reducing bacteria (SRB), saprophytic bacteria (TGB), iron oxidizing bacteria (IOB), etc. are the main microbial groups that cause localized corrosion of iron and steel materials such as pipelines, pipe fittings, and plates, of which SRB have the highest content and the most harmful effects among the microbial groups causing corrosion of iron and steel materials.

In addition, in many cases there are working environments where microbiologically caused corrosion and CO₂ corrosion coexist. However, the corrosion resistance of steel products in the prior art is often limited to CO₂ corrosion only or to microbiologically caused corrosion only, and there are no products that are resistant to both CO₂ and microbiologically caused corrosion.

For example, for CO₂ corrosion, products such as 3Cr and 13Cr are available.

CN107177792A (disclosed on Sep. 19, 2017, “Pipeline steel with sulfate reducing bacterium corrosion resistance”) discloses a pipeline steel having a chemical composition comprising one or more of: C≤0.10%, Si≤0.50%, Mn≤2.0%, 1.5%≤Cu≤4.0%, Ni≤0.60%, Mo<0.30%, Cr<0.30%, Nb<0.05%, Ti<0.05%, and the balance of Fe and inevitable impurities. Although this pipeline steel has excellent resistance to sulfate reducing bacteria corrosion, it does not have CO₂ corrosion resistance.

CN 107805762A (disclosed on Mar. 16, 2018, “A low alloy high strength steel resistant to corrosion caused by marine microorganisms”) discloses a low alloy steel comprising the following chemical elements: C: 0-0.08%, Si: 0-0.40%, Mn: 0-1.8%, Cu: 0.6-4.0%, Ni: 0.6-1.0%, Mo: 0-0.6%, Cr: 0-0.60%, Nb: 0-0.05%, and the balance of Fe and inevitable impurities. This low alloy high strength steel significantly reduces the risk of corrosion caused by marine Pseudomonas aeruginosa microorganism. Although the low alloy steel has excellent resistance to Pseudomonas aeruginosa microorganism corrosion, it does not have resistance to CO₂ corrosion.

### SUMMARY

Considering the above deficiencies in the field, it is expected to obtain a steel grade that combines good resistance to CO₂ and microbiologically caused corrosion.

Accordingly, one of the objectives of the present disclosure is to provide a low alloy steel having good resistance to CO₂ and microbiologically caused corrosion for working environments where microbiologically caused corrosion and CO₂ corrosion coexist.

In order to achieve the above objective, the present disclosure provides a low alloy steel, comprising, in addition to Fe and inevitable impurities, the following chemical elements in percentage by mass:
C: 0.02-0.1%, Si: 0.1-1.5%, Mn: 0.10-1.8%, Cr: 1.0-5.5%, Ni: 0.3-3.0%, Cu: 0.3-4.8%, Mo: 0.10-2.5%, V: 0.01-0.2%, Al: 0.01-0.1%, REM: 0.1-1.0%.

On the other hand, the present disclosure also provides a low alloy steel having the following chemical elements in percentage by mass:
C: 0.02-0.1%, Si: 0.1-1.5%, Mn: 0.10-1.8%, Cr: 1.0-5.5%, Ni: 0.3-3.0%, Cu: 0.3-4.8%, Mo: 0.10-2.5%, V: 0.01-0.2%, Al: 0.01-0.1%, REM: 0.1-1.0%, and the balance of Fe and inevitable impurities.

Preferably, in the low alloy steel of the present disclosure, rare earth elements (REM elements) comprise at least La and Ce and their content in percentage by mass satisfies: 0.05%≤(La+Ce)≤0.55%.

Preferably, in the low alloy steel of the present disclosure, the Cu content in percentage by mass is 1.5-4.8%, preferably 2.0-4.8%.

Preferably, in the low alloy steel of the present disclosure, the Cr content in percentage by mass is 2.0-5.5%, preferably 3.0-5.5%.

Preferably, in the low alloy steel of the present disclosure, the Ni content in percentage by mass is 1.0-3.0%, preferably 1.5-3.0%.

Preferably, in the low alloy steel of the present disclosure, the Mo content in percentage by mass is 1.0-2.5%.

Preferably, in the low alloy steel of the present disclosure, the V content in percentage by mass is 0.1-0.2%.

Preferably, in the low alloy steel of the present disclosure, the REM comprises La and Ce, wherein the content of La and Ce in percentage by mass satisfies the following inequality: 0.05%≤(La+Ce)≤0.55%, preferably 0.24%≤(La+Ce)≤0.52%.

Preferably, in the low alloy steel of the present disclosure, the inevitable impurities comprise P and S, wherein the content of P and S in percentage by mass satisfies the following: P≤0.015%, S≤0.007%.

Preferably, the low alloy steel has a microstructure of ferrite and pearlite.

Preferably, in the presence of CO₂, SRB, TGB and IOB, the low alloy steel has a general corrosion rate of ≤0.015 mm/a and a pitting corrosion rate of ≤0.033 mm/a.

On the other hand, the present disclosure also provides a plate made from the above low alloy steel.

On the other hand, the present disclosure also provides a welded pipe made from the above low alloy steel.

On the other hand, the present disclosure also provides a method for manufacturing the above plate, comprising the following steps:
1) Smelting and casting to produce a slab;
2) Rolling;
3) Heat treatment;
4) Air-cooling,
wherein, in step 3), a heat treatment temperature is 860-950° C. and a holding time is 30 min or more.

Preferably, in step 2), a heating temperature of the slab is 1150-1280° C. and a finishing rolling temperature is 850-980° C.

On the other hand, the present disclosure also provides a method for manufacturing the above welded pipe, comprising the following steps:
1) Smelting and casting to produce a slab;
2) Rolling;
3) Welding and forming to produce a welded pipe;
4) Heat treatment;
5) Air-cooling,
wherein, in step 4), a heat treatment temperature is 860-950° C. and a holding time is 30 min or more.

Preferably, in step 2), a heating temperature of the slab is 1150-1280° C. and a finishing rolling temperature is 850-980° C.

### DETAILED DESCRIPTION

The low alloy steel, plate, welded pipe, and the method for manufacturing thereof of the present disclosure will be further explained and illustrated in connection with specific embodiments as follows. However, the explanation and illustration do not unduly limit the technical solutions of the present disclosure.

As described in the Examples section, the corrosion resistance test was conducted in an environment where CO₂, SRB, TGB, and IOB coexisted at a temperature of 35° C., a CO₂ partial pressure of 1.5 MPa, a SRB concentration of 40,000 SRBs/ml, a TGB concentration of 25,000 TGBs/ml, and a IOB concentration of 30,000 IOBs/ml, and the test time was 250 h.

In the low alloy steel of the present disclosure, the design principles for each chemical element are described below:
C: C is conducive to increasing the strength of steel, but too much C tends to lead to precipitation of alloying element carbides at grain boundaries, which reduces the steel's resistance to CO₂ and microbiologically caused corrosion. In addition, from the viewpoint of weldability, C will also strongly increase the weld crack sensitivity of the steel. Therefore, the C content is controlled at 0.02-0.10%.
Si: Si is an important deoxidizer in the steelmaking process. In addition, Si can also improve high temperature oxidation and acid resistance. In order to ensure the deoxidizing effect of steel, the Si content needs to be kept at 0.1% or more, but too much content will reduce the toughness and plasticity of steel. Therefore, the Si content is limited to 0.1-1.5%.
Mn: Mn has the beneficial effects of expanding the austenite phase region, increasing hardenability, grain refinement and so on. However, too much Mn has a significant adverse effect on welding performance and hot processing performance. Therefore, the Mn content is controlled at 0.10-1.80%.
Cr: Cr can significantly improve the steel resistance to CO₂ localized corrosion and general corrosion. When the Cr content is less than 1.0%, excellent CO₂ corrosion resistance cannot be guaranteed. However, Cr is not the higher the better, because the segregation of Cr carbides at grain boundaries tends to lead to a decrease in the corrosion resistance of the steel. On the other hand, the weldability will be affected if Cr is too high. Therefore, after comprehensive consideration, the Cr content is designed to 1.0-5.5%, preferably 2.0-5.5%, and more preferably 3.0-5.5%.
Ni: Ni can significantly improve the performance of the passivation film and enhance the corrosion resistance of the steel. Ni can also improve the problem of slab cracking during steelmaking. Therefore, the Ni content is controlled at 0.3-3.0%, preferably 1.0-3.0%, more preferably 1.5-3.0%.
Cu: Cu is a key alloying element in the low alloy steel of the present disclosure and is essential to ensure the resistance to microbiologically caused corrosion. Cu is uniformly dispersed in the substrate as a copper-rich phase. Under working conditions, copper ions can be continuously dissolved and adsorbed on the steel surface, thereby preventing the growth of sulfate reducing bacteria adsorbed on the steel surface, and thus providing a bactericidal effect. However, excessive Cu can lead to the precipitation of coarse copper-rich phases, which affects the impact toughness and hot processing performance. Therefore, the Cu content is controlled at 0.3-4.8%, preferably 1.5-4.8%.
Mo: Mo can increase the strength of steel through carbide and solid solution strengthening, and it is also effective in increasing the pitting corrosion resistance of the steel. Therefore, the Mo content is controlled at 0.1-2.5%, preferably 1.0-2.5%.
V: V is a typical precipitation strengthening element, which can improve the strength of steel. When the V content is less than 0.01%, the strengthening effect is not obvious; when the V content is more than 0.20%, there will be more coarse precipitation phase, which affects the toughness and corrosion resistance of the steel. Therefore, the V content is controlled at 0.01-0.20%, preferably 0.1-0.2%.
Al: As a deoxidizing element of the low alloy steel of the present disclosure, the Al content is controlled at 0.01-0.10%.
REM: REM can effectively improve the toughness and CO₂ corrosion resistance of the steel, in which La and Ce can effectively enhance the resistance to microbiologically caused corrosion of the steel. However, the total amount of REM as well as the content of La and Ce should not be too much, because too much of them will produce more coarse inclusions and affect the toughness and corrosion resistance of the steel. Therefore, the REM content is controlled at 0.10-1.0%, wherein 0.05%≤[La]+[Ce]≤0.55%.
P: P is a harmful element that leads to a decrease in CO₂ corrosion resistance and adversely affects hot processing performance. If the P content exceeds 0.015%, the CO₂ corrosion resistance cannot meet the requirement. Therefore, the P content is limited to 0.015% or less.
S: S is a harmful element that reduces hot processing performance and adversely affects impact toughness. If the S content exceeds 0.007%, the welded pipe cannot be manufactured properly. Therefore, the S content is limited to 0.007% or less, preferably 0.005% or less.

From a compositional point of view, in the low alloy steel of the present disclosure, the surface passivation film is improved by adding an appropriate amount of Cr element to form Cr(OH)₃ for improving the corrosion product protection ability, which in turn improves the CO₂ corrosion resistance of the steel; and the resistance to microbiologically caused corrosion of the steel is enhanced by adding an appropriate amount of Cu. In the microbial environment, Cu ions and Cu-rich phases can be released continuously to ensure a lasting resistance to microbiologically caused corrosion. In addition, the pitting corrosion resistance of steel can be effectively increased by adding an appropriate amount of Mo. Moreover, La and Ce have toxic effects to SRB, TGB, IOB microorganisms, while REM has a certain effect on enhancing CO₂ corrosion resistance. Therefore, the addition of REM comprising La and Ce elements can enhance the resistance to CO₂ and microbiologically caused corrosion at the same time.

From a process point of view, in the method for manufacturing the plate and welded pipe of the present disclosure, complete austenitization can be ensured by making the heat treatment temperature between 860-950° C. During the heat treatment process, Cr(OH)₃ is formed on the surface of the material, which enhances the CO₂ corrosion resistance. Meanwhile, Cu precipitates in a manner of copper-rich phase, which is beneficial for enhancing the resistance to microbiologically caused corrosion.

In summary, the low alloy steel resistant to CO₂ and microbiologically caused corrosion of the present disclosure obtains a ferrite and pearlite microstructure through a reasonable chemical composition design in conjunction with a specific heat treatment process. At the same time, the low alloy steel has a general corrosion rate of ≤0.015 mm/a and pitting corrosion rate of ≤0.033 mm/a in an environment where CO₂, SRB, TGB and IOB coexist, indicating an excellent resistance to CO₂ and microbiologically caused corrosion.

In addition, the low alloy steel of the present disclosure has a simple chemical composition and a low alloying element addition, leading to a low economic cost, which has good promotion prospect and application value.

The present disclosure is described in further detail below in connection with the Examples. The following Examples are used only to illustrate the present disclosure and are not intended to unduly limit the scope of the present disclosure. The experimental methods for which specific conditions are not indicated in the Examples are in accordance with conventional conditions known in the field, or in accordance with conditions suggested by the manufacturer.

### Examples A-E

Examples A-1 to E-1 are plates made from low alloy steel using the compositions shown in Table 1, and Examples A-2 to E-2 are welded pipes made from low alloy steel using the compositions shown in Table 1.

The plates of Examples A-1 to E-1 were produced using the following steps (see Table 2 for specific process parameters):
(1) Compounding raw material according to the compositions shown in Table 1, smelting and casting to produce a slab;
(2) Rolling: a heating temperature of the slab was 1150-1280° C., and a finishing temperature was 850-980° C.;
(3) Heat treatment: a heat treatment temperature was 860-950° C., and a holding time was 30 min or more;
(4) Air-cooling.

The welded pipes of Examples A-2 to E-2 were produced using the following steps (see Table 3 for specific process parameters):
(1) Compounding raw material according to the compositions shown in Table 1, smelting and casting to produce a slab;
(2) Rolling of the slab to produce a hot-rolled plate, wherein a heating temperature of the slab was 1150-1280° C., and a finishing temperature was 850-980° C.;
(3) Welding and forming to produce a welded pipe
(4) Heat treatment: a heat treatment temperature was 860-950° C., and a holding time was 30 min or more;
(5) Air-cooling.

Table 1 lists each chemical element in percentage by mass for the low alloy steels of Examples A-E.

TABLE 1
Examples A-E (wt %, the balance is Fe and inevitable impurities other than P and S)

| | | | | | | | | | | | | REM | | |
|---|---|---|---|---|---|---|---|---|---|---|---|---|---|---|
| | | | | | | | | | | | | Total | | |
| Example | C | Si | Mn | P | S | Cr | Ni | Cu | Mo | V | Al | Amount | La | Ce |
| A | 0.08 | 0.8 | 0.10 | 0.015 | 0.002 | 2.0 | 1.5 | 1.5 | 0.1 | 0.2 | 0.01 | 0.30 | 0.07 | 0.09 |
| B | 0.10 | 0.1 | 0.8 | 0.015 | 0.002 | 3.0 | 0.3 | 2.0 | 1.5 | 0.10 | 0.08 | 0.50 | 0.12 | 0.12 |
| C | 0.04 | 1.2 | 1.8 | 0.012 | 0.007 | 5.5 | 2.0 | 3.0 | 2.0 | 0.15 | 0.05 | 0.80 | 0.21 | 0.10 |
| D | 0.06 | 0.3 | 1.2 | 0.015 | 0.002 | 4.0 | 3.0 | 4.8 | 2.5 | 0.01 | 0.10 | 1.0 | 0.30 | 0.22 |
| E | 0.02 | 1.5 | 0.50 | 0.015 | 0.002 | 1.0 | 1.0 | 0.3 | 1.0 | 0.06 | 0.03 | 0.1 | 0.06 | 0.03 |

Table 2 lists the specific process parameters for the methods for manufacturing the plates of Examples A-1 to E-1.

TABLE 2

| | Slab heating | Finishing rolling | Heat treatment | Holding |
|---|---|---|---|---|
| | temperature | temperature | temperature | time |
| Example | (° C.) | (° C.) | (° C.) | (min) |
| A-1 | 1280 | 980 | 920 | 35 |
| B-1 | 1220 | 900 | 950 | 30 |
| C-1 | 1260 | 950 | 900 | 40 |
| D-1 | 1150 | 850 | 880 | 45 |
| E-1 | 1180 | 880 | 860 | 50 |

Table 3 lists the specific process parameters for the methods for manufacturing the welded pipes of Examples A-2 to E-2.

TABLE 3

| | Slab heating | Finishing rolling | Heat treatment | Holding |
|---|---|---|---|---|
| | temperature | temperature | temperature | time |
| Example | (° C.) | (° C.) | (° C.) | (min) |
| A-2 | 1150 | 850 | 950 | 30 |
| B-2 | 1180 | 880 | 860 | 60 |
| C-2 | 1280 | 980 | 890 | 50 |
| D-2 | 1200 | 920 | 900 | 45 |
| E-2 | 1250 | 960 | 920 | 40 |

The plates and welded pipes of each of the above examples were tested for corrosion resistance, and the test results obtained are listed in Table 4. The specific test methods are as follows:

The corrosion test was conducted in an environment where CO₂, SRB, TGB, and IOB coexisted, and the specimens taken from each example were immersed in a liquid in a container at a temperature of 35° C., a CO₂ partial pressure of 1.5 MPa, a SRB concentration of 40,000 SRBs/ml, a TGB concentration of 25,000 TGBs/ml, and a IOB concentration of 30,000 IOBs/ml, and the test time was 250 h. The general corrosion rate was calculated by comparing the weight of the specimens before and after the test. The pitting corrosion rate was calculated by cross-section analysis of the pitting pits.

Table 4 lists the corrosion resistance test results for the plates of Examples A-1 to E-1 and the welded pipes of Examples A-2 to E-2.

TABLE 4

| | General corrosion rate | Pitting corrosion rate |
|---|---|---|
| No. | (mm/a) | (mm/a) |
| Example A-1 | 0.0085 | 0.0204 |
| Example B-1 | 0.0102 | 0.0308 |
| Example C-1 | 0.0150 | 0.0321 |
| Example D-1 | 0.0075 | 0.0187 |
| Example E-1 | 0.0122 | 0.0288 |
| Example A-2 | 0.0076 | 0.0197 |
| Example B-2 | 0.0115 | 0.0296 |
| Example C-2 | 0.0142 | 0.0312 |
| Example D-2 | 0.0068 | 0.0167 |
| Example E-2 | 0.0132 | 0.0273 |

As can be seen from Table 4, the general corrosion rate of each Example is ≤0.015 mm/a and the pitting corrosion rate is ≤0.033 mm/a in the environment where CO₂, SRB, TGB, and IOB coexisted. It can be seen that the low alloy steel of the present disclosure has excellent resistance to CO₂ and microbiologically caused corrosion. Although the present disclosure has been described by reference to certain preferred embodiments of the present disclosure, it should be understood by those skilled in the art that the foregoing is a further detailed description of the present disclosure in conjunction with specific embodiments. It cannot be assumed that the specific embodiments of the present disclosure are confined only to these descriptions. Those skilled in the art may make various changes to the forms and details thereof, including making a number of simple deductions or substitutions, without departing from the spirit and scope of the present disclosure.

1. A low alloy steel, comprising, in addition to Fe and inevitable impurities, the following chemical elements in percentage by mass:
C: 0.02-0.1%, Si: 0.1-1.5%, Mn: 0.10-1.8%, Cr: 1.0-5.5%, Ni: 0.3-3.0%, Cu: 0.3-4.8%, Mo: 0.10-2.5%, V: 0.01-0.2%, Al: 0.01-0.1%, REM: 0.1-1.0%.

2. The low alloy steel as claimed in claim 1, characterized in that, the low alloy steel has the following chemical elements in percentage by mass:
C: 0.02-0.1%, Si: 0.1-1.5%, Mn: 0.10-1.8%, Cr: 1.0-5.5%, Ni: 0.3-3.0%, Cu: 0.3-4.8%, Mo: 0.10-2.5%, V: 0.01-0.2%, Al: 0.01-0.1%, REM: 0.1-1.0%, and the balance of Fe and inevitable impurities.

3. The low alloy steel as claimed in claim 1 or 2, characterized in that, the low alloy steel satisfies at least one of the following conditions in percentage by mass: Cu: 1.5-4.8%, preferably 2.0-4.8%; Cr: 2.0-5.5%, preferably 3.0-5.5%; Ni: 1.0-3.0%, preferably 1.5-3.0%; Mo: 1.0-2.5%; and/or V: 0.1-0.2%.

4. The low alloy steel as claimed in claim 1 or 2, characterized in that, the REM comprises La and Ce, wherein the content of La and Ce in percentage by mass satisfies the following inequality: 0.05%≤(La+Ce)≤0.55%, preferably 0.24%≤(La+Ce)≤0.52%.

5. The low alloy steel as claimed in claim 1 or 2, characterized in that, the inevitable impurities comprise P and S, wherein the content of P and S in percentage by mass satisfies the following: P≤0.015%, S≤0.007%.

6. The low alloy steel as claimed in claim 1 or 2, characterized in that, the low alloy steel has a microstructure of ferrite and pearlite.

7. The low alloy steel as claimed in claim 1 or 2, characterized in that, in the presence of CO₂, SRB, TGB and IOB, the low alloy steel has a general corrosion rate of ≤0.015 mm/a and a pitting corrosion rate of ≤0.033 mm/a.

8. A plate made from the low alloy steel as claimed in any one of claims 1-6.

9. A welded pipe made from the low alloy steel as claimed in any one of claims 1-6.

10. A method for manufacturing the plate as claimed in claim 8, comprising the following steps:
1) Smelting and casting to produce a slab;
2) Rolling;
3) Heat treatment;
4) Air-cooling,
wherein, in step 3), a heat treatment temperature is 860-950° C. and a holding time is 30 min or more.

11. The method as claimed in claim 10, characterized in that, in step 2), a heating temperature of the slab is 1150-1280° C. and a finishing rolling temperature is 850-980° C.

12. A method for manufacturing the welded pipe as claimed in claim 9, comprising the following steps:
1) Smelting and casting to produce a slab;
2) Rolling;
3) Welding and forming to produce a welded pipe;
4) Heat treatment;
5) Air-cooling,
wherein, in step 4), a heat treatment temperature is 860-950° C. and a holding time is 30 min or more.

13. The method as claimed in claim 12, characterized in that, in step 2), a heating temperature of the slab is 1150-1280° C. and a finishing rolling temperature is 850-980° C.
